(19) United States
(12) Patent Application Publication
(10) Pub. No.: US 2010/0100815 A1
(43) Pub. Date: Apr. 22, 2010

(54) EMAIL DOCUMENT PARSING METHOD AND APPARATUS

(75) Inventors: Ben Hutchinson, Chatswood (AU); Tanja Gaustad, Chatswood (AU); Dominique Estival, Chatswood (AU); Wil Radford, Chatswood (AU); Son Bao Pham, Chatswood (AU)

Correspondence Address: GEORGE A LEONE, SR;CITADEL PATENT LAW, 1117 BROADWAY, SUITE 401, TACOMA, WA, 98402, US

(73) Assignee: APPEN PTY LIMITED, Chatswood, New South Wales (AU)

(21) Appl. No.: 12/447,898

(22) PCT Filed: Apr. 5, 2007
(86) PCT No.: PCT/AU07/00440

§ 371 Date: Nov. 19, 2009

(30) Foreign Application Priority Data
Nov. 3, 2006 (AU) 2006906095
Nov. 28, 2006 (AU) 2006906623
Apr. 5, 2007 (AU) PCT/AU2007/000440

(51) Int. Cl. G06F 17/00; G06F 17/27; G06F 15/16

(52) U.S. Cl. 715/256; 704/9; 709/206

(57) ABSTRACT

A preferred example of the process flow of the inventive method (1) is depicted in FIG. 1). The first step (2) of the method (1) is to import an email document (3) to be parsed. In the preprocessing step (10) the email (3) is processed to determine the presence of any header text (5) (excluding any header text that may be within the embedded reply chain) or attachments 4, including attached email documents, if any. Once the header text (5), attachments (4) or other forwarded materials have been identified in the preprocessing step (10), these components of the email (3) are categorized by the computer (51) as non-author composed text. Next the process flow of the parsing computer (51) moves to the step of normalization (11). This entails processing the email document (3) to ascertain whether it is in a preferred format and, if the email document (3) is not in the preferred format, converting at least some of the information within the email document to the preferred format. The parsing computer (51) now progresses through several analysis steps, referred to as the segmentation step (12), the linguistic analysis step (13) and the punctuation analysis step (14). The results of these analysis steps (12) to (14) are recorded in suitable memory or storage means accessible to the CPU of the parsing computer (51). In the segmentation step (12) the text of email (3) is split into paragraphs, and the paragraphs are split into sentences. The linguistic analysis step (13) includes identification of predefined words and phrases of various types. In the punctuation analysis step (14) the parsing computer (51) analyses the text at the character level so as to check for use of sentence punctuation marks and other predefined characters. At the completion of the analysis steps (12) to (14), the process flow proceeds to step (15), in which the analysed email document, including any annotations that have been inserted, is saved into the memory of the computing apparatus, along with any extraneous results of the analysis. Next a number of features are defined at step (18). Typically, a feature is a descriptive statistic calculated from either or both of the raw text and the annotations. At step (19) the features extracted at step (18) are converted into data structures associated with segments of the text. At step (20) the machine learning system receives the data structures and associated lines of text as input and is responsive to that input so as to categorise each line of text as broadly falling into one of two categories: author composed text or non-author composed text.

### STATEMENT RE U.S. GOVERNMENT RIGHTS

This invention was made with U.S. Government support under Contract No. W91CRB-06-C-0012 awarded by U.S. Army RDECOM ACQ CTR-W91CRB. The U.S. Government has certain rights in this invention.

### FIELD OF THE INVENTION

The present invention relates to a method and apparatus for parsing electronic mail (also known as “email”) documents. Embodiments of the present invention find application, though not exclusively, in the field of computational text processing, which is also known in some contexts as natural language processing, human language technology or computational linguistics. The outputs of some preferred embodiments of the invention may be used in a wide range of computing tasks such as automatic email categorization techniques, sentiment analysis, author attribution, and the like.

### BACKGROUND OF THE INVENTION

The use of electronic mail, or “email”, has become increasingly pervasive throughout the last decade and hence the data contained within email messages may constitute a valuable source of data to some entities, particularly those that either receive or intercept a large volume of email traffic. To assist in extracting and analysing data from emails it is useful in some contexts to focus analysis upon text that has been composed by the author of the email and to disregard other types of text that may be included with typical email documents.

It has been appreciated by the inventors of the present invention that the known prior art attempts to automatically parse text from emails can suffer from a number of disadvantages. In particular, the known prior art identifies only a very limited range of types of non-author composed text and utilises fairly unsophisticated processing techniques. Additionally, the known prior art is typically restricted to analysing emails that are composed in the English language and which are expressed in the ASCII character set. Further, at least some of the prior art was developed at a point in time that was prior to the use of email becoming extremely widespread and such prior art is therefore not well adapted to parse the contemporary genre of email expression.

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

### SUMMARY OF THE INVENTION

It is an object of the present invention to overcome, or substantially ameliorate, one or more of the disadvantages of the prior art, or to provide a useful alternative.

In accordance with a first aspect of the present invention there is provided a computer implemented method of parsing an email document so as to categorize text from the email document as author composed text or non-author composed text, said method including the steps of:

processing the text to determine the presence of signature text and categorizing any such signature text as non-author composed text;

processing the text to determine the presence of automatically appended advertisement text and categorizing any such automatically appended advertisement text as non-author composed text;

processing the text to determine the presence of quotation text and categorizing any such quotation text as non-author composed text;

processing the text to determine the presence of text contained in an embedded reply chain of email messages and categorizing any such text contained in an embedded reply chain of email messages as non-author composed text; and

categorizing at least some of the remaining text as author composed text.

Preferably at least one of the text processing steps includes a linguistic analysis of the words in the text. In one preferred embodiment the linguistic analysis includes identification of predefined words and phrases of any one or more of the following types:

peoples' names, locations, dates, times, organizations, currency, uniform resource locators (URL's), email addresses, addresses, organizational descriptors, phone numbers, typical greetings and/or typical farewells. Such a preferred embodiment typically includes a database of words and phrases of any one or more of the said types. For some applications preferred embodiments of the invention further include the step of anonymising information contained within the text of the email document.

Preferably at least one of the text processing steps includes an analysis of the punctuation used in the text. Also preferably, at least one of the text processing steps includes an analysis of the paragraph and sentence segmentation used in the text.

In a preferred embodiment the results of the linguistic analysis, the punctuation analysis and the paragraph and sentence segmentation are represented by one or more data structures associated with segments of the text. Preferably the segments of the text are lines of the text, although in other embodiments alternative segments are used.

Preferably at least one of the text processing steps further includes utilizing a machine learning system that is responsive to the one or more data structures. In a preferred embodiment the data structures are feature vectors and the machine learning system utilizes any one or more of the following techniques:

Conditional Random Fields;

Support Vector Machines;

Naïve Bayes;

Decision Trees; and/or

Maximum Entropy.

Preferably the machine learning system has been trained with reference to a representative sample of email documents in which at least a proportion of the email documents are contemporary. As used in this document, the concept of a “contemporary email document” should be construed as being an email document that was originally authored within the preceding two year period.

A preferred embodiment includes a step of processing the text to determine the presence of header text and categorizing any such header text as non-author composed text. This preferred embodiment also includes a step of processing the email document to determine the presence of any attachments and stripping any such attachments from the email document prior to processing the text. Another step taken by this preferred embodiment relates to processing the email document to determine the presence of any forwarded material and stripping any such forwarded material from the email document prior to processing the text. Yet another step taken by the preferred embodiment relates to processing the email document to ascertain whether the email document is in a preferred format and, if the email document is not in the preferred format, converting at least some of the information within the email document to the preferred format.

In another aspect of the present invention there is provided a computer-readable medium containing computer executable code for instructing a computer to perform a method in accordance with the first aspect of the present invention.

In yet another aspect of the present invention there is provided a downloadable or remotely executable file or combination of files containing computer executable code for instructing a computer to perform a method in accordance with the first aspect of the present invention.

In a yet further aspect of the present invention there is provided a computing apparatus having a central processing unit, associated memory and storage devices, and input and output devices, said apparatus being configured to perform a method according to the first aspect of the present invention.

The features and advantages of the present invention will become further apparent from the following detailed description of preferred embodiments, provided by way of example only, together with the accompanying drawings.

### BRIEF DESCRIPTION OF THE ACCOMPANYING DRAWINGS

FIG. 1 is a flow chart illustrating the main processing steps carried out by a preferred embodiment of the invention;

FIG. 2 is a schematic depiction of a typical email document; and

FIG. 3 is a schematic depiction of a preferred embodiment of a computing apparatus according to the invention.

### DETAILED DESCRIPTION OF PREFERRED EMBODIMENTS OF THE INVENTION

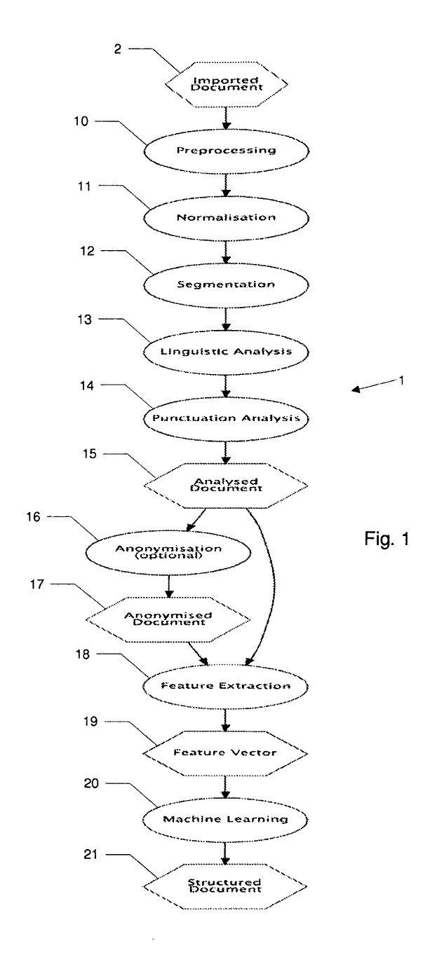

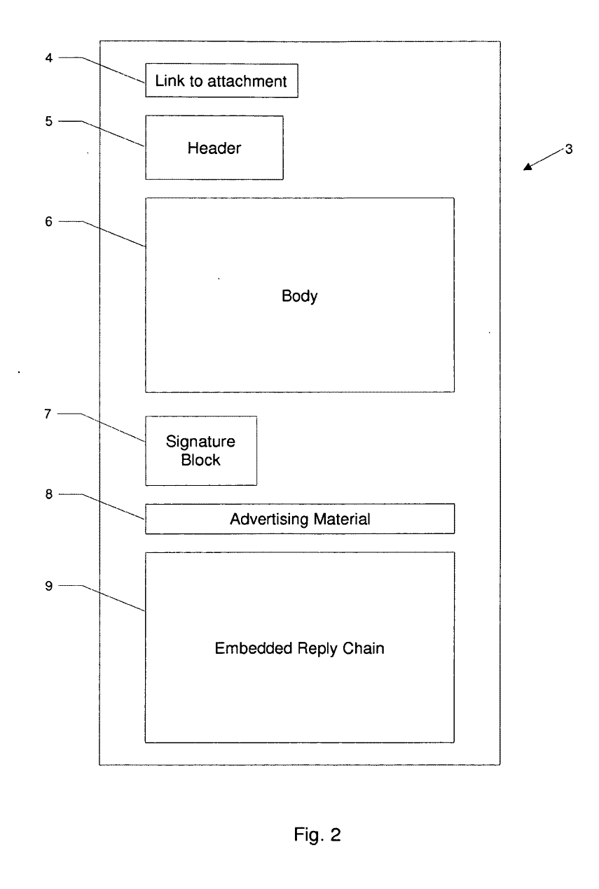

A preferred example of the process flow of the inventive method 1 is depicted in FIG. 1. The first step 2 of the method 1 is to import an email document 3 to be parsed. A typical email document 3 may include some or all of a number of different sections, as shown schematically in FIG. 2. These sections may consist of, for example, a link 4 to one or more attachments, a header 5, a body 6, a signature block 7, some automatically appended advertisement materials 8 and/or an embedded reply chain of previous email messages 9. It will be appreciated that the ordering and number of occurrences of these various sections 4 to 9 may vary from that depicted in FIG. 2. With the exception of the link to an attachment 4, each of the sections 5 to 9 are at least initially coded by the processing computer as a single block of text, with the divisions between the various sections being typically initially unknown to the processing computer. In other words, the header 5, body 6, signature block 7, advertisement 8 and the embedded reply chain 9 are typically all encoded as a single unparsed text field.

In some embodiments each email 3 is imported and parsed in real time immediately after receipt or interception. In other embodiments, a database of received or intercepted emails is maintained and each email 3 is imported from the database as required, either immediately after receipt, or at some later point in time. In the preferred embodiment, an original copy of the email 3 is stored for later reference, and all analysis takes place upon a copy of the original.

It will be appreciated that the actual hardware platform upon which the invention is implemented will vary depending upon the amount of processing power required. In some embodiments the computing apparatus is a stand alone computer, whilst in other embodiments the computing apparatus is formed from a networked array of interconnected computers.

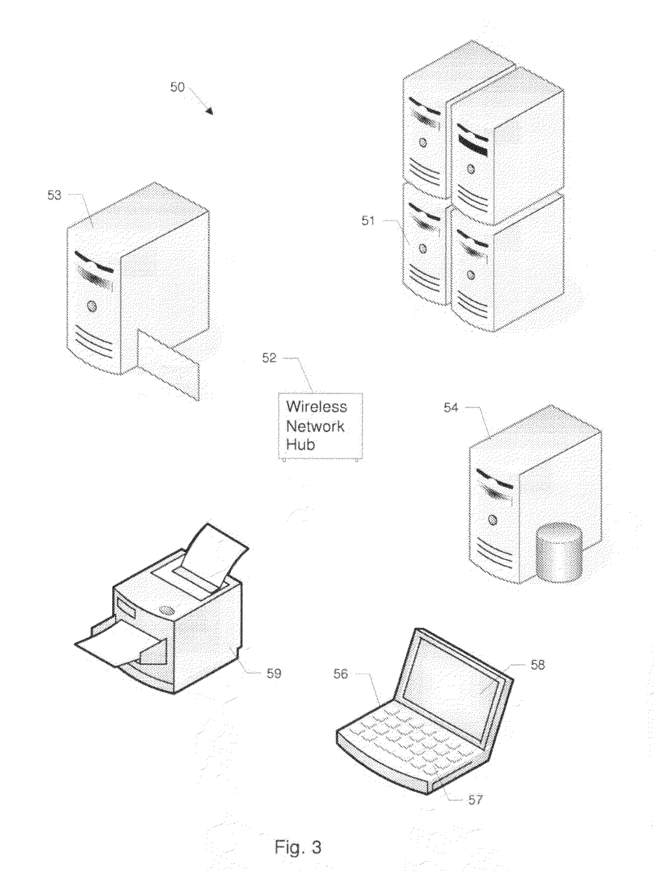

The preferred embodiment utilizes a computing apparatus 50 as shown in FIG. 3, which is configured to perform the parsing processing. This computing apparatus includes a computer 51 having a central processing unit (CPU); associated memory, in particular RAM and ROM; storage devices such as hard drives, writable CD ROMS and flash memory. The computer 51 is also communicatively connected via a wireless network hub 52 to an email server 53, a database server 54 and a laptop computer 56, which functions as a user interface to the networked hardware. The laptop computer 56 provides the user with input devices such as a keyboard 57 and a mouse (not illustrated); and a display in the form of a screen 58. The laptop computer 56 is also communicatively connected via the wireless network hub 52 to an output device in the form of a printer 59. The email server 53 includes an external communications link in the form of a modem. Email messages 3 are received by the email server 55 and relayed via the wireless network hub 52 to the computer 51 for parsing. Depending upon user requirements, a copy of the email 3 may also be stored on the database server 54.

For the sake of a running example, the processing of the following exemplary email document shall be described:

```
---Original Message---
From: Commercial Services
Sent: Monday, May 08, 2006 3:23 PM
To: ‘jbloggs@hotmail.com’
Subject: RE: Special Request
Hi Joe,
Thank you for inquiring about our Commercial Services
program. Thank you for
your recent Commercial Services inquiry. The B&W Commercial
Services
program can give you one-stop convenience for all of your
upkeep and
commercial improvement needs, including online change of
address and utilities
connections with the QC product. Here is the link to access
this
information: http://commercialservices.bw.com. The vendors
are listed
by category and their contact information is also available
on-line. In
order to receive quotes on the services you've requested,
it is advised
to directly contact that vendor as Commercial Services does
not have access to
pricing information.
If you require any moving services, however, please feel
free to browse
our website for our movers' information and then call us at
888.572.9427
so that we can set up an appointment for an estimate.
If you have any questions, please don't hesitate to email
or call at
888.572.9427.
Best Regards,
The Commercial Services Team
888.572.9427
commercialservices@bw.com
---Original Message---
From: jbloggs@hotmail.com [mailto:jbloggs@hotmail.com]
Sent: Monday, May 08, 2006 3:13 PM
To: Commercial Services
Subject: Special Request
BW Commercial Services-Special Request
Submitted
      Time: 5/8/2006 4:12:32 PM
Origins
      Origin: Our Site
      Origin 2:
Message from
      Name: Joe Bloggs
      E-mail: jbloggs@hotmail.com
      Phone: (507) 359-7891
      Additional Phone:
      Contact Method: phone
      Contact Time: Evening (5:00 pm-8:00 pm)
      Contact ASAP: Yes
Customer responses
      I'm interested in renting, and I would like:
            More information on your Commercial Services
program
B&W - Your Favorite Commercial Services Provider Since 1875
```

In the preprocessing step 10 the email 3 is processed to determine the presence of any header text 5 (excluding any header text that may be within the embedded reply chain) or attachments 4, including attached email documents, if any. This preprocessing is relatively straight forward for those skilled in the art. It may be thought of as a basic “cleaning up” of the email 3 prior to more sophisticated parsing. In some embodiments the preprocessing step 10 takes place in real time immediately prior to the parsing steps described below. In other embodiments, the preprocessing 10 takes place separately from the remaining steps, for example when a copy of the email 3 is saved on the database server 54 for future parsing.

Once the header text 5, attachments 4 or other forwarded materials have been identified in the preprocessing step 10, these components of the email 3 are categorized by the computer 51 as non-author composed text. In the preferred embodiment the recordal of such categorization is achieved by inserting annotations into the text, for example by:

inserting the tag “<header>” at the commencement of the header 5; and

inserting the tag “</header>” at the conclusion of the header 5.

As applied to the running example, this results in the following annotated header text 5:

<header>---Original Message---
From: Commercial Services
Sent: Monday, May 08, 2006 3:23 PM
To: ‘jbloggs@hotmail.com’
Subject: RE: Special Request</header>

Alternative embodiments record the categorization by means other than by inserting annotations into the text. In one such embodiment, the text that has been categorized is copied into a memory location or bulk storage location that is exclusively reserved for the relevant category of text. In yet another embodiment the appearance of the categorized text is altered, for example by altering the background or foreground colour or font of the categorized text. In a further embodiment the annotations are stored in an annotation repository, along with pointer data indicating the positions within the text of the email 3 to which the annotation is applicable. It will be appreciated that many other means for recording the categorization of text may be devised by those skilled in the art. In further alternative embodiments, any header text 5, attachments 4 or other forwarded materials are simply stripped from the version of the email 3 that progresses to the further parsing steps.

Subsequent to preprocessing 10, the process flow of the parsing computer 51 moves to the step of normalization 11. This entails processing the email document 3 to ascertain whether it is in a preferred format and, if the email document 3 is not in the preferred format, converting at least some of the information within the email document to the preferred format. More particularly, the imported emails 3 may be in any one of a variety of character sets and encodings, for example US-ASCII, UTF-8, ISO-8859-1, ISO-8859-2, ISO-8859-6, windows-1251, windows-1252 or windows-1256. Occasionally documents may have headers which specify an incorrect encoding (e.g. a UTF-8 document may have a header claiming it is ISO-8859-1). In such cases, a set of heuristics are used to guess at the correct encoding. Once the encoding is known, all text in formats other than UTF-8 is converted to UTF-8 so as to provide a single consistent format for the parsing to follow. Of course, formats other than UTF-8 are used as preferred formats in other embodiments.

The process flow of the parsing computer 51 now progresses through several analysis steps, referred to as the segmentation step 12, the linguistic analysis step 13 and the punctuation analysis step 14. The results of these analysis steps 12 to 14 are recorded in suitable memory or storage means accessible to the CPU of the parsing computer 51. In the segmentation step 12 the text of email 3 is split into paragraphs, and the paragraphs are split into sentences. In the preferred embodiment this segmentation analysis 12 is performed by a publicly available third party tool, known as the General Architecture for Text Engineering (GATE) segmentation tool, which is distributed by The University of Sheffield. Other third party segmentation tools, such those provided by Stanford University, may also be utilised.

The preferred embodiment records segmentation using annotations inserted in the text. As applied to the running example, this results in the following annotated email text:

```
<header>---Original Message---
From: Commercial Services
Sent: Monday, May 08, 2006 3:23 PM
To: ‘jbloggs@hotmail.com’
Subject: RE: Special Request</header>
<paragraph>Hi Joe,</paragraph>
<paragraph><sentence>Thank you for inquiring about our
Commercial Services program.</sentence><sentence>Thank you
for your recent Commercial Services
inquiry.</sentence><sentence>The B&W Commercial Services
program can give you one-stop convenience for all of your
upkeep and commercial improvement needs, including online
change of address and utilities connections with the QC
product.</sentence><sentence>Here is the link to access
this information:
http://commercialservices.bw.com.</sentence><sentence>The
vendors are listed by category and their contact
information is also available on-
line.</sentence><sentence>In order to receive quotes on the
services you've requested, it is advised to directly
contact that vendor as Commercial Services does not have
access to pricing information.</sentence></paragraph>
<paragraph><sentence>If you require any moving services,
however, please feel free to browse our website for our
movers' information and then call us at 888.572.9427 so
that we can set up an appointment for an
estimate.</sentence></paragraph>
<paragraph><sentence>If you have any questions, please
don't hesitate to email or call at
888.572.9427.</sentence></paragraph>
<paragraph>Best Regards,
The Commercial Services Team
888.572.9427
commercialservices@bw.com</paragraph>
<paragraph>---Original Message---
From: jbloggs@hotmail.com [mailto:jbloggs@hotmail.com]
Sent: Monday, May 08, 2006 3:13 PM
To: Commercial Services
Subject: Special Request</paragraph>
<paragraph>BW Commercial Services-Special
Request</paragraph>
<paragraph>Submitted
      Time: 5/8/2006 4:12:32 PM</paragraph>
<paragraph>Origins
      Origin: Our Site
      Origin 2:</paragraph>
<paragraph>Message from
      Name: Joe Bloggs
      E-mail: jbloggs@hotmail.com
      Phone: (507) 359-7891
      Additional Phone:
      Contact Method: phone
      Contact Time: Evening (5:00 pm-8:00 pm)
      Contact ASAP: Yes </paragraph>
<paragraph>Customer
responses
<sentence>I'm interested in renting, and I would
like:</sentence>
<sentence>More information on your Commercial Services
program</sentence></paragraph>
<paragraph>B&W - Your Favorite Commercial Services Provider
Since 1875</paragraph>
```

Following segmentation analysis, the parsing computer 51 performs linguistic analysis of the words in the text at step 13. This analysis includes identification of predefined words and phrases of various types. An exemplary list of some of the types of words and phrases that are identified in this stage of the analysis is set out in table 1.

TABLE 1

| Word or Phrase Type | Examples |
|---|---|
| peoples' names | “James”, “Jane” |
| Locations | “Sydney”, “United Arab Emirates” |
| Dates | “23/10/2006”, |
| | “Monday the 23rd of June” |
| times | “noon”, “12:30pm” |
| organizations | “Microsoft”, “IBM” |
| Currency | “$20”, “£16” |
| uniform resource locators (URL's) | “http://www.google.com” |
| email addresses | “joe.blogg@domain.com” |
| addresses | “29 High Street” |
| organizational descriptors | “Dept.”, “Division” |
| phone numbers | +61 2 9476 0477 |
| typical greetings | “Hi”, “Dear” |
| typical farewells | “Best regards”, “Cheers” |

The preferred embodiment has an extensive database of examples of such types of words and phrases, which functions as a lexicon to assist in the identification of such key words and phrases. This data is stored in database server 54. In the preferred embodiment the results of the linguistic analysis are inserted as annotations into the text in the manner described above. As applied to the running example, this results in the following annotated email text (for the sake of clarity only some of the possible annotations are shown here):

```
<header>---Original Message---
From: <Organization>Commercial Services</Organization>
Sent: <Date>Monday, May 08, 2006</Date> <Time>3:23
PM</Time>
To: ‘<Email>jbloggs@hotmail.com</Email>’
Subject: RE: Special Request</header>
<paragraph>Hi <Person>Joe</Person>,</paragraph>
<paragraph><sentence>Thank you for inquiring about our
<Organization>Commercial Services</Organization>
program.</sentence> <sentence>Thank you for your recent
<Organization>Commercial Services</Organization>
inquiry.</sentence> <sentence>The <Organization>B&W
Commercial Services</Organization> program can give you
one-stop convenience for all of your upkeep and commercial
improvement needs, including online change of address and
utilities connections with the QC product.</sentence>
<sentence>Here is the link to access this information:
<Url>http://commercialservices.bw.com</Url>.</sentence>
<sentence>The vendors are listed by category and their
contact information is also available on-line.</sentence>
<sentence>In order to receive quotes on the services you've
requested, it is advised to directly contact that vendor as
<Organization>Commercial Services</Organization> does not
have access to pricing information.</sentence></paragraph>
<paragraph><sentence>If you require any moving services,
however, please feel free to browse our website for our
movers' information and then call us at
<Phone>888.572.9427</Phone> so that we can set up an
appointment for an estimate.</sentence></paragraph>
<paragraph><sentence>If you have any questions, please
don't hesitate to email or call at
<Phone>888.572.9427</Phone>.</sentence></paragraph>
<paragraph>Best Regards,
The <Organization>Commercial Services</Organization> Team
<Phone>888.572.9427</Phone>
<Email>commercialservices@bw.com</Email></paragraph>
<paragraph>---Original Message---
From: <Email>jbloggs@hotmail.com</Email>
[mailto:<Email>jbloggs@hotmail.com</Email>]
Sent: <Date>Monday, May 08, 2006</Date> <Time>3:13
PM</Time>
To: <Organization>Commercial Services</Organization>
Subject: Special Request</paragraph>
<paragraph><Organization>BW Commercial
Services</Organization> - Special request</paragraph>
<paragraph>Submitted
      Time: <Date>5/8/2006</Date> <Time>4:12:32
PM</Time></paragraph>
<paragraph>Origins
      Origin: Our Site
      Origin 2:</paragraph>
<paragraph>Message from
      Name: <Person>Joe Bloggs</Person>
      E-mail: <Email>jbloggs@hotmail.com</Email>
      Phone: <Phone>(507) 359-7891</Phone>
      Additional Phone:
      Contact Method: phone
      Contact Time: Evening (<Time>5:00 pm</Time>-
<Time>8:00 pm</Time>)
      Contact ASAP: Yes </paragraph>
<paragraph>Customer
responses
<sentence>I'm interested in renting, and I would
like:</sentence>
<sentence>More information on your <Organization>Commercial
Services</Organization> program</sentence></paragraph>
<paragraph><Organization>B&W<Organization> - Your Favorite
<Organization>Commercial Services</Organization> Provider
Since 1875</paragraph>
```

Punctuation analysis takes place at step 14 of the process flow. In this step the parsing computer 51 analyses the text at the character level so as to check for use of sentence punctuation marks and other predefined characters, such as:

special markers, e.g. two hyphens “--” (which often indicate that an email signature follows);

the greater-than character “>” (which often indicate the presence of reply lines); quotation marks (which may signal the presence of a quotation);

emoticons (e.g. “:-)”, “:o)”) (which are typically indicative of either an emotive state of the author, or an emotive state that the author wishes to elicit from the recipient of the email).

At the completion of the analysis steps 12 to 14, the process flow proceeds to step 15, in which the analysed email document, including any annotations that have been inserted, is saved into the memory of the computing apparatus, along with any extraneous results of the analysis.

Steps 16 and 17 are optional and relate to the anonymisation of the document. This entails stripping some of the text identified in the linguistic analysis step 13, such as the names of people, locations, phone numbers, URLs, and emails addresses so as to remove any information that may identify one or more parties associated with the email. This typically entails stripping text from the body 6 of the email 3, and also from any signatures 7 and headers 5. For many applications it is not necessary to anonymise the email text, in which case steps 16 and 17 are omitted and the parsing processing instead proceeds directly from step 15 to step 18.

To summarise the results of the processing that has occurred to this point a number of features are defined at step 18. Typically, a feature is a descriptive statistic calculated from either or both of the raw text and the annotations. For example, a feature might express the ratio of frequencies of two different annotation types (e.g. the ratio of sentence annotations to paragraph annotations), or the presence or absence of an annotation type (e.g. greeting). More particularly, the features can be generally divided into three groupings:
Character level features—which summarise the analysis of each individual character in the text of the email. Typically the results of the punctuation analysis step 14 provide the majority of these features. Examples include:
   proportion of characters that are:
      alphabetic,
      numeric,
      white space,
      punctuation, and
      special symbols;
   proportion of words with less than four characters; and
   mean word length.
Lexical level features—which summarise the keywords and phrases, emoticons, multiword prepositional phrases, farewell expressions, greeting expressions, part-of-speech tags, etc. identified during the linguistic analysis step 13. Examples include:
   frequency and distribution of different parts of speech;
   word type-token ratio;
   frequency distribution of specific function words drawn from the keyword database; and
   frequency distribution of multiword prepositions; and proportion of words that are function words.
Structural level features—which typically refer to the annotations made regarding structural features of the text such as the presence of a signature block, reply status, attachments, headers, etc. Examples include information regarding:
   indentation of paragraphs;
   presence of farewells;
   document length in characters, words, lines, sentences and/or paragraphs; and
   mean paragraph length in lines, sentences and/or words.

Information regarding the categories, descriptions and names of the various features that are calculated for a typical email document 3 in the preferred embodiment is set out in the following table:

| Feature Category | Feature Description | Feature Name |
|---|---|---|
| CHARACTERS | | |
| | All chars | Char_count_all |
| | | Char_ratio_inWord_all |
| alpha | Alpha chars | Char_ratio_alpha_all |
| upperCase | Upper case chars | Char_ratio_upperCase_all |
| | | Char_ratio_upperCase_alpha |
| lowerCase | Lower case chars | |
| digit | Lower case chars | Char_ratio_digit_all |
| whiteSpace | White spaces | Char_ratio_space_whiteSpace |
| | | Char_ratio_whiteSpace_all |
| space | Spaces | Char_ratio_space_all |
| tab | Tabs | Char_count_tab |
| | | Char_ratio_tab_all |
| | | Char_ratio_tab_whiteSpace |
| punctuation | Punctuation | Char_count_punctuation |
| | | Char_ratio_punctuation_all |
| alphabeticA through alphabeticZ | character A, etc. | Char_count_alphabeticA, etc. |
| punc44 | punctuation character , | Char_count_punc44 |
| punc46 | punctuation character . | Char_count_punc46 |
| punc63 | punctuation character ? | Char_count_punc63 |
| punc33 | punctuation character ! | Char_count_punc33 |
| punc58 | punctuation character : | Char_count_punc58 |
| punc59 | punctuation character ; | Char_count_punc59 |
| punc39 | punctuation character ' | Char_count_punc39 |
| punc34 | punctuation character ” | Char_count_punc34 |
| specialChar126 | special character ~ | Char_count_specialChar126 |
| specialChar64 | special character @ | Char_count_specialChar64 |
| specialChar35 | special character # | Char_count_specialChar35 |
| specialChar36 | special character $ | Char_count_specialChar36 |
| specialChar37 | special character % | Char_count_specialChar37 |
| specialChar94 | special character | Char_count_specialChar94 |
| specialChar38 | special character & | Char_count_specialChar38 |
| specialChar42 | special character * | Char_count_specialChar42 |
| specialChar45 | special character - | Char_count_specialChar45 |
| specialChar95 | special character _{—} | Char_count_specialChar95 |
| specialChar61 | special character = | Char_count_specialChar61 |
| specialChar43 | special character + | Char_count_specialChar43 |
| specialChar60 | special character < | Char_count_specialChar60 |
| specialChar62 | special character > | Char_count_specialChar62 |
| specialChar91 | special character [ | Char_count_specialChar91 |
| specialChar93 | special character ] | Char_count_specialChar93 |
| specialChar123 | special character { | Char_count_specialChar123 |
| specialChar125 | special character } | Char_count_specialChar125 |
| specialChar92 | special character \ | Char_count_specialChar92 |
| specialChar47 | special character / | Char_count_specialChar47 |
| specialChar124 | special character \| | Char_count_specialChar124 |
| WORDS | | |
| Word | All word Tokens | Word_count_all |
| | | Word_meanLengthIn_Char |
| | | Word_ratio_wordType_all |
| shortWord | Short words of length less than 4 | Word_ratio_shortWord_all |
| | characters | |
| functionWord | Function words from predefined | Word_ratio_functionWord_all |
| | lexicon such as: up, to | |
| wordLength | Intermediate entities consisting of | Word_ratio_wordLen1_all, etc. |
| | entities having various word lengths | |
| | 1-30 characters | |
| posTag | Intermediate entities consisting of | Word_ratio_posTag_all |
| | entities of various part-of-speech | |
| | types | |
| posNN | Words its part-of-speech equal NN | Word_ratio_posNN_all |
| posVBT | Words its part-of-speech equal VBT | Word_ratio_posVBT_all |
| posVBU | Words its part-of-speech equal | Word_ratio_posVBU_all |
| | VBU | |
| posIN | Words its part-of-speech equal IN | Word_ratio_posIN_all |
| posJJ | Words its part-of-speech equal JJ | Word_ratio_posJJ_all |
| posRB | Words its part-of-speech equal RB | Word_ratio_posRB_all |
| posPR | Words its part-of-speech equal PR | Word_ratio_posPR_all |
| posNNP | Words its part-of-speech equal NNP | Word_ratio_posNNP_all |
| posPOS | Words its part-of-speech equal POS | Word_ratio_posPOS_all |
| posMD | Words its part-of-speech equal MD | Word_ratio_posMD_all |
| caseUpper | Words of character case type upper | Word_ratio_caseUpper_all |
| caseLower | Words of character case type lower | Word_ratio_caseLower_all |
| caseCamel | Words of character case type camel | Word_ratio_caseCamel_all |
| caseFirstUpper | Words of character case type | Word_ratio_caseFirstUpper_all |
| | firstUpper | |
| caseSlowShiftRelease | Words of character case type | Word_ratio_caseSlowShiftRelease_all |
| | slowShiftRelease | |
| caseSingletonUpper | Words of character case type | Word_ratio_caseSingletonUpper_all |
| | singletonUpper | |
| CorrelateEducated | Words correlating with author trait | Word_ratio_CorrelateEducated_all |
| | Educated | |
| CorrelateFemale | Words correlating with author trait | Word_ratio_CorrelateFemale_all |
| | Female | |
| CorrelateHighAgreeableness | Words correlating with author trait | Word_ratio_CorrelateHighAgreeableness_all |
| | HighAgreeableness | |
| CorrelateHighConscientiousness | Words correlating with author trait | Word_ratio_CorrelateHighConscientiousness_all |
| | HighConscientiousness | |
| CorrelateHighExtraversion | Words correlating with author trait | Word_ratio_CorrelateHighExtraversion_all |
| | HighExtraversion | |
| CorrelateHighNeuroticism | Words correlating with author trait | Word_ratio_CorrelateHighNeuroticism_all |
| | HighNeuroticism | |
| CorrelateHighOpenness | Words correlating with author trait | Word_ratio_CorrelateHighOpenness_all |
| | HighOpenness | |
| CorrelateLowAgreeableness | Words correlating with author trait | Word_ratio_CorrelateLowAgreeableness_all |
| | LowAgreeableness | |
| CorrelateLowConscientiousness | Words correlating with author trait | Word_ratio_CorrelateLowConscientiousness_all |
| | LowConscientiousness | |
| CorrelateLowExtraversion | Words correlating with author trait | Word_ratio_CorrelateLowExtraversion_all |
| | LowExtraversion | |
| CorrelateLowNeuroticism | Words correlating with author trait | Word_ratio_CorrelateLowNeuroticism_all |
| | LowNeuroticism | |
| CorrelateLowOpenness | Words correlating with author trait | Word_ratio_CorrelateLowOpenness_all |
| | LowOpenness | |
| CorrelateMale | Words correlating with author trait | Word_ratio_CorrelateMale_all |
| | Male | |
| CorrelateNonUS | Words correlating with author trait | Word_ratio_CorrelateNonUS_all |
| | NonUS | |
| CorrelateOld | Words correlating with author trait | Word_ratio_CorrelateOld_all |
| | Old | |
| CorrelateUneducated | Words correlating with author trait | Word_ratio_CorrelateUneducated_all |
| | Uneducated | |
| CorrelateUS | Words correlating with author trait | Word_ratio_CorrelateUS_all |
| | US | |
| CorrelateYoung | Words correlating with author trait | Word_ratio_CorrelateYoung_all |
| | Young | |
| Wordclasses | all wordclasses annotations | Word_ratio_wordClass_all |
| wordclassesSP | wordclass spelling error (SP) | Word_ratio_wordClassSP_all |
| wordclassesTP | wordclass typing error (TP) | Word_ratio_wordClassTP_all |
| wordclassesCF | wordclass creative wordformation | Word_ratio_wordClassCF_all |
| | (CF) | |
| wordclassesAB | wordclass abbreviation (AB) | Word_ratio_wordClassAB_all |
| wordclassesWS | wordclass missing whitespace (WS) | Word_ratio_wordClassWS_all |
| wordclassesGR | wordclass grammatical error (GR) | Word_ratio_wordClassGR_all |
| wordclassesFW | wordclass foreign word (FW) | Word_ratio_wordClassFW_all |
| MULTIWORD | | |
| PREPOSITIONS | | |
| MultiwordPrepositions | All multiword prepositions (mwp) | MultiwordPreposition_count_all |
| | | MultiwordPreposition_ratio_all_allWords |
| | | MultiwordPreposition_meanLengthIn_Word |
| | | MultiwordPreposition_meanLengthIn_Char |
| mwp0 through mwp19 | mwp's from predefined lexicon | MultiwordPreposition_ratio_mwp1_all |
| FUNCTION WORDS | | |
| FunctionWord | All annotations of function words | FunctionWord_count_all |
| function0 through 149 | Annotations matching function | FunctionWord_ratio_function0_all, etc. |
| | word lexicon | |
| GREETINGS | | |
| Greeting | All annotations of greeting words | Greeting_count_all |
| greeting0 through greeting86 | Annotations matching greeting | Greeting_count_greeting0, etc. |
| | lexicon | |
| FAREWELLS | | |
| Farewell | All annotations of farewell words | Farewell_count_all |
| farewell0 through farewell186 | Annotations matching farewell | Farewell_count_farewell0, etc. |
| | lexicon | |
| EMOTICONS | | |
| Emoticon | All annotations representing | Emoticon_count_all |
| | emoticon symbols | |
| emoticon0 through emoticon70 | Annotations matching emoticon | Emoticon_count_emoticon0, etc. |
| | lexicon | |
| LINES | | |
| Line | All lines strings | Line_count_all |
| | | Line_meanLengthIn_Char |
| blank | Blank lines | Line_ratio_blank_all |
| SENTENCES | | |
| Sentence | All sentence annotations | Sentence_count_all |
| | | Sentence_meanLengthIn_Char |
| | | Sentence_meanLengthIn_Word |
| PARAGRAPHS | | |
| Paragraph | All paragraph annotations | Paragraph_count_all |
| | | Paragraph_meanLengthIn_Char |
| | | Paragraph_meanLengthIn_Word |
| | | Paragraph_meanLengthIn_Sentence |
| indented | Paragraphs with the first line | Paragraph_ratio_indented_all |
| | indented | |
| HTML | | |
| html | HTML annotations, and annotations | HTML_count_all |
| | concerning the HTML | HTML_ratio_all_allWords |
| | | HTML_meanLengthIn_Char |
| | | HTML_meanLengthIn_Word |
| htmlTag | Intermediate entities consisting of | HTML_ratio_htmlTag_all |
| | entities of various HTML tags | |
| htmlFontAttributeSize1 through | HTML font tag with attribute size = | HTML_ratio_htmlFontAttributeSize1_htmlTag, |
| Size7 | 1, etc. | etc. |
| htmlFontAttributeSize−1 | HTML font tag with attribute size = | HTML_ratio_htmlFontAttributeSize−1_htmlTag |
| | −1 | |
| htmlFontAttributeSize+1 | HTML font tag with attribute size = | HTML_ratio_htmlFontAttributeSize+1_htmlTag |
| | +1 | |
| htmlFontAttributeSize−2 | HTML font tag with attribute size = | HTML_ratio_htmlFontAttributeSize−2_htmlTag |
| | −2 | |
| htmlFontAttributeColorNavy | HTML font tag with attribute color = | HTML_ratio_htmlFontAttributeColorNavy_htmlTag |
| | navy | |
| htmlFontAttributeColorTeal | HTML font tag with attribute color = | HTML_ratio_htmlFontAttributeColorTeal_htmlTag |
| | teal | |
| htmlFontAttributeColorLime | HTML font tag with attribute color = | HTML_ratio_htmlFontAttributeColorLime_htmlTag |
| | lime | |
| htmlFontAttributeColorGreen | HTML font tag with attribute color = | HTML_ratio_htmlFontAttributeColorGreen_htmlTag |
| | green | |
| htmlFontAttributeColorSilver | HTML font tag with attribute color = | HTML_ratio_htmlFontAttributeColorSilver_htmlTag |
| | silver | |
| htmlFontAttributeColorFuchsia | HTML font tag with attribute color = | HTML_ratio_htmlFontAttributeColorFuchsia_htmlTag |
| | fuchsia | |
| htmlFontAttributeColorWhite | HTML font tag with attribute color = | HTML_ratio_htmlFontAttributeColorWhite_htmlTag |
| | white | |
| htmlFontAttributeColorYellow | HTML font tag with attribute color = | HTML_ratio_htmlFontAttributeColorYellow_htmlTag |
| | yellow | |
| htmlFontAttributeColorBlack | HTML font tag with attribute color = | HTML_ratio_htmlFontAttributeColorBlack_htmlTag |
| | black | |
| htmlFontAttributeColorPurple | HTML font tag with attribute color = | HTML_ratio_htmlFontAttributeColorPurple_htmlTag |
| | purple | |
| htmlFontAttributeColorOlive | HTML font tag with attribute color = | HTML_ratio_htmlFontAttributeColorOlive_htmlTag |
| | olive | |
| htmlFontAttributeColorRed | HTML font tag with attribute color = | HTML_ratio_htmlFontAttributeColorRed_htmlTag |
| | red | |
| htmlFontAttributeColorMaroon | HTML font tag with attribute color = | HTML_ratio_htmlFontAttributeColorMaroon_htmlTag |
| | maroon | |
| htmlFontAttributeColorAqua | HTML font tag with attribute color = | HTML_ratio_htmlFontAttributeColorAqua_htmlTag |
| | aqua | |
| htmlFontAttributeColorGray | HTML font tag with attribute color = | HTML_ratio_htmlFontAttributeColorGray_htmlTag |
| | gray | |
| htmlFontAttributeColorBlue | HTML font tag with attribute color = | HTML_ratio_htmlFontAttributeColorBlue_htmlTag |
| | blue | |
| htmlFontAttributeColorOther | HTML font tag with attribute color = | HTML_ratio_htmlFontAttributeColorOther_htmlTag |
| | other | |
| htmlFontAttributeFaceArial | HTML font tag with attribute face = | HTML_ratio_htmlFontAttributeFaceArial_htmlTag |
| | arial | |
| htmlFontAttributeFaceVerdana | HTML font tag with attribute face = | HTML_ratio_htmlFontAttributeFaceVerdana_htmlTag |
| | verdana | |
| htmlFontAttributeFaceTahoma | HTML font tag with attribute face = | HTML_ratio_htmlFontAttributeFaceTahoma_htmlTag |
| | tahoma | |
| htmlFontAttributeFaceGaramond | HTML font tag with attribute face = | HTML_ratio_htmlFontAttributeFaceGaramond_htmlTag |
| | garamond | |
| htmlFontAttributeFaceGeorgia | HTML font tag with attribute face = | HTML_ratio_htmlFontAttributeFaceGeorgia_htmlTag |
| | georgia | |
| htmlFontAttributeFaceWingdings | HTML font tag with attribute face = | HTML_ratio_htmlFontAttributeFaceWingdings_htmlTag |
| | wingdings | |
| htmlFontAttributeFacePapyrus | HTML font tag with attribute face = | HTML_ratio_htmlFontAttributeFacePapyrus_htmlTag |
| | papyrus | |
| htmlFontAttributeFaceDefault | HTML font tag with attribute face = | HTML_ratio_htmlFontAttributeFaceDefault_htmlTag |
| | default | |
| htmlTagB | HTML <B> tags | HTML_ratio_htmlTagB_htmlTag |
| htmlTagI | HTML <I> tags | HTML_ratio_htmlTagI_htmlTag |
| htmlTagSTRONG | HTML <STRONG> tags | HTML_ratio_htmlTagSTRONG_htmlTag |
| htmlTagU | HTML <U> tags | HTML_ratio_htmlTagU_htmlTag |
| htmlTagTT | HTML <TT> tags | HTML_ratio_htmlTagTT_htmlTag |
| htmlTagSMALL | HTML <SMALL> tags | HTML_ratio_htmlTagSMALL_htmlTag |
| htmlTagBIG | HTML <BIG> tags | HTML_ratio_htmlTagBIG_htmlTag |
| htmlTagEM | HTML <EM> tags | HTML_ratio_htmlTagEM_htmlTag |
| htmlTagTABLE | HTML <TABLE> tags | HTML_ratio_htmlTagTABLE_htmlTag |
| htmlTagTR | HTML <TR> tags | HTML_ratio_htmlTagTR_htmlTag |
| htmlTagTD | HTML <TD> tags | HTML_ratio_htmlTagTD_htmlTag |
| htmlTagHR | HTML <HR> tags | HTML_ratio_htmlTagHR_htmlTag |
| htmlTagCENTER | HTML <CENTER> tags | HTML_ratio_htmlTagCENTER_htmlTag |
| htmlTagLI | HTML <LI> tags | HTML_ratio_htmlTagLI_htmlTag |
| htmlTagUL | HTML <UL> tags | HTML_ratio_htmlTagUL_htmlTag |
| AUTHOR_TEXT | | |
| AuthorText | All author text annotations | AuthorText_count_all |
| REPLY | | |
| Reply | All reply annotations | Reply_count_all |
| SIGNATURE | | |
| Signature | All signatare annotations | Signature_count_all |
| PERSONAL | | |
| personal | all category personal annotations | personal_count_all |
| PROFESSIONAL | | |
| professional | all category professional | professional_count_all |
| | annotations | |
| BUSINESS | | |
| business | all category business annotations | business_count_all |
| TIME | | |
| Time | All Time annotations | Time_count_all |
| | | Time_ratio_all_allWords |
| | | Time_meanLengthIn_Char |
| | | Time_meanLengthIn_Word |
| time24 | Time annotations such as 23:15 or | Time_ratio_time24_all |
| | 08:15 | |
| timeAMPM | Time annotations having am or pm | Time_ratio_timeAMPM_all |
| | tokens e.g. 8:15 am | |
| timeOClock | Time annotations such as 5 o'clock | Time_ratio_timeOClock_all |
| timeAmbiguous | Time annotations that are | Time_ratio_timeAmbiguous_all |
| | ambiguous e.g. 8:15 | |
| MONEY | | |
| Money | All Money annotations | Money_count_all |
| | | Money_ratio_all_allWords |
| | | Money_meanLengthIn_Char |
| | | Money_meanLengthIn_Word |
| hasDollarSign | Money annotations having a dollar | Money_ratio_hasDollarSign_all |
| | sign e.g. $5.0 | |
| PERSON | | |
| Person | All Person annotations | Person_count_all |
| | | Person_ratio_all_allWords |
| | | Person_meanLengthIn_Char |
| | | Person_meanLengthIn_Word |
| hasTitle | Person annotations having a title | Person_ratio_hasTitle_all |
| | e.g. Mr. John Smith | |
| DATE | | |
| Date | All Date annotations | Date_count_all |
| | | Date_ratio_all_allWords |
| | | Date_meanLengthIn_Char |
| | | Date_meanLengthIn_Word |
| dateNum | Date annotations with numeric | Date_ratio_dateNum_all |
| | month component | |
| dateWorded | Date annotations with worded | Date_ratio_dateWorded_all |
| | month component | |
| hasDay | Date annotations with a day | Date_ratio_hasDay_all |
| | specified | |
| hasYear | Date annotations with a year | Date_ratio_hasYear_all |
| | specified | |
| dateUK | Numeric Date annotations written | Date_ratio_dateUK_dateNum |
| | in UK format e.g. 30/12/2005 | |
| dateUS | Numeric Date annotations written | Date_ratio_dateUS_dateNum |
| | in US format e.g. Dec. 30, 2005 | |
| dateAmbiguous | Numeric Date annotations with | Date_ratio_dateAmbiguous_dateNum |
| | ambiguous(US or UK) style e.g. | |
| | 5/6/2005 | |
| monthDate | Worded Date annotations with | Date_ratio_monthDate_dateWorded |
| | month before date e.g. July 7th | |
| dateMonth | Worded Date annotations with date | Date_ratio_dateMonth_dateWorded |
| | before month e.g. 7th of July | |
| ADDRESS | | |
| Address | all address annotations | Address_count_all |
| | | Address_meanLengthIn_Char |
| | | Address_meanLengthIn_Word |
| | | Address_ratio_all_allWords |
| EMAIL | | |
| Email | all email annotations | Email_count_all |
| | | Email_meanLengthIn_Char |
| | | Email_meanLengthIn_Word |
| | | Email_ratio_all_allWords |
| LOCATION | | |
| Location | all location annotations | Location_count_all |
| | | Location_meanLengthIn_Char |
| | | Location_meanLengthIn_Word |
| | | Location_ratio_all_allWords |
| ORGANIZATION | | |
| Organization | all organization annotations | Organization_count_all |
| | | Organization_meanLengthIn_Char |
| | | Organization_meanLengthIn_Word |
| | | Organization_ratio_all_allWords |
| PERCENT | | |
| Percent | all percent annotations | Percent_count_all |
| | | Percent_meanLengthIn_Char |
| | | Percent_mcanLengthIn_Word |
| | | Percent_ratio_all_allWords |
| PHONE | | |
| Phone | all phone annotations | Phone_count_all |
| | | Phone_meanLengthIn_Char |
| | | Phone_meanLengthIn_Word |
| | | Phone_ratio_all_allWords |
| URL | | |
| Url | all Url annotations | Url_count_all |
| | | Url_meanLengthIn_Char |
| | | Url_meanLengthIn_Word |
| | | Url_ratio_all_allWords |

It will be appreciated by those skilled in the art that in the above feature list “char” is short for “character” and the numbers after the terms “punc” and “specialChar” refer to the American Standard Code for Information Interchange (ASCII). Hence, for example, the feature Char_count_punc33 is a numeric value equal to the number of times ASCII code 33 (i.e. !) is used in the document being parsed. Some of the other features mentioned in the above list are counts and/or ratios associated with user-defined lexicons of commonly used emoticons, farewells, function words, greetings and multiword prepositions. Each of the feature names is a variable that is set to a numeric value that is calculated for the respective feature. For example, for an email comprised of 488 characters, the feature char_count_all is set to a value of 488.

At step 19 the features extracted at step 18 are converted into data structures associated with segments of the text. The type of data structure chosen must be suitable for use with the type of machine learning system that will be used in step 20. The preferred embodiment uses feature vectors as the preferred data structure and makes use of the Conditional Random Fields technique in the machine learning system. Each of the feature vectors is associated with a line of the text of the email 3. A feature vector is essentially a list of features that is structured in a predefined manner to function as input for the Conditional Random Field processing that occurs at the next step.

At step 20 the machine learning system, using the Conditional Random Fields technique, receives the feature vectors and associated lines of text as input and is responsive to that input so as to categorise each line of text as broadly falling into one of two categories: author composed text or non-author composed text. More specifically, the category of non-author composed text is divided into five sub-categories as follows:

1. signature text 7;

2. automatically appended advertisement text 8;

3. quotation text;

4. text contained in an embedded reply chain of email messages 9; and

5. header text 5.

In the preferred embodiment, if the text does not fall into any of these five sub-categories of non-author composed text, it is categorized as author composed text. Since header text 5 is typically identified in the preprocessing step 10, the machine learning categorization step 20 focuses upon identifying the other four sub-categories of non-author composed text.

Once the parsing is complete, the results are stored in accordance with a storage protocol. The preferred embodiment once again makes use of annotations, as described in detail above, to record the results of the parsing. The identified sub-categories of non-author composed text are denoted by the following tags: <header>, <quote>, <signature>, <reply> and <advert>. The text that does not fall into any of these non-author composed sub-categories is categorized as author composed text and is annotated with the following tag: <AuthorText>. With reference to the running example, the annotated text reads as follows:

```
<header>---Original Message---
From: <Organization>Commercial Services</Organization>
Sent: <Date>Monday, May 08, 2006</Date> <Time>3:23
PM</Time>
To: ‘<Email>jbloggs@hotmail.com</Email>’
Subject: RE: Special Request</header>
<AuthorText><paragraph>Hi <Person>Joe</Person>,</paragraph>
<paragraph><sentence>Thank you for inquiring about our
<Organization>Commercial Services</Organization>
program.</sentence> <sentence>Thank you for your recent
<Organization>Commercial Services</Organization>
inquiry.</sentence> <sentence>The <Organization>B&W
Commercial Services</Organization> program can give you
one-stop convenience for all of your upkeep and commercial
improvement needs, including online change of address and
utilities connections with the QC product.</sentence>
<sentence>Here is the link to access this information:
<Url>http://commercialservices.bw.com</Url>.</sentence>
<sentence>The vendors are listed by category and their
contact information is also available on-line.</sentence>
<sentence>In order to receive quotes on the services you've
requested, it is advised to directly contact that vendor as
<Organization>Commercial Services</Organization> does not
have access to pricing information.</sentence></paragraph>
<paragraph><sentence>If you require any moving services,
however, please feel free to browse our website for our
movers' information and then call us at
<Phone>888.572.9427</Phone> so that we can set up an
appointment for an estimate.</sentence></paragraph>
<paragraph><sentence>If you have any questions, please
don't hesitate to email or call at
<Phone>888.572.9427</Phone>.</sentence></paragraph>
<paragraph>Best Regards,
<signature>The <Organization>Commercial
Services</Organization> Team
<Phone>888.572.9427</Phone>
<Email>commercialservices@bw.com</Email></signature></paragraph>
</AuthorText>
<reply><paragraph>---Original Message---
From: <Email>jbloggs@hotmail.com</Email>
[mailto:<Email>jbloggs@hotmail.com</Email>]
Sent: <Date>Monday, May 08, 2006</Date> <Time>3:13
PM</Time>
To: <Organization>Commercial Services</Organization>
Subject: Special Request</paragraph>
<paragraph><Organization>BW Commercial
Services</Organization> - Special request</paragraph>
<paragraph>Submitted
      Time: <Date>5/8/2006</Date> <Time>4:12:32
PM</Time></paragraph>
<paragraph>Origins
      Origin: Our Site
      Origin 2:</paragraph>
<paragraph>Message from
      Name: <Person>Joe Bloggs</Person>
      E-mail: <Email>jbloggs@hotmail.com</Email>
      Phone: <Phone>(507) 359-7891</Phone>
      Additional Phone:
      Contact Method: phone
      Contact Time: Evening (<Time>5:00 pm</Time>-
<Time>8:00 pm</Time>)
      Contact ASAP: Yes </paragraph>
<paragraph>Customer
responses
<sentence>I'm interested in renting, and I would
like:</sentence>
<sentence>More information on your <Organization>Commercial
Services</Organization>
program</sentence></paragraph></reply>
<advert><paragraph><Organization>B&W<Organization> - Your
Favorite <Organization>Commercial Services</Organization>
Provider Since 1875</paragraph></advert>
```

The above annotated email text represents an example of a structured document 21, which is the final output of the preferred method 1. Note that not all of the annotations generated during steps 12 to 14 are included in the output of the method 1, for example some of the annotations associated with character level features are not included.

Other embodiments are specifically tailored to recognize further sub-categories of non-authored text, however it has been appreciated by the inventors of the present invention that identification of the five sub-categories of non-author composed text that are set out above is sufficient to identify the vast bulk of non-author composed text present in a typical representative sample of email messages as at the priority date of this patent application. In other words, restricting the identification of non-authored text to the five sub-categories set out above represents a workable compromise between accuracy and processing requirements.

The machine learning system makes use of a predictive model that is established during a training phase, in which the machine learning system receives training data consisting of pairs of feature vectors and lines statuses, where the status of a line can be any one of: author composed text 6; automatically appended advertisement text 8; signature text 7; embedded reply chain text 9 or quotation text. The training data is compiled from a representative sample of email documents 3, at least some of which are preferably contemporary. Once sufficient training iterations have been completed, the machine learning system formulates the predictive model that is used in the machine learning categorization of step 20.

In addition to, or as an alternative to, the Conditional Random Fields technique, various other preferred embodiments make use of one or more of the following types of known machine learning techniques, including:

Support Vector Machines;

Nave Bays;

Decision Trees; and/or

Maximum Entropy.

It will be appreciated by those skilled in the art that the present invention may be embodied in computer software in the form of executable code for instructing a computer to perform the inventive method. The software and its associated data are capable of being stored upon a computer-readable medium in the form of one or more compact disks (CD's). Alternative embodiments make use of other forms of digital storage media, such as Digital Versatile Discs (DVD's), hard drives, flash memory, Erasable Programmable Read-Only Memory (EPROM), and the like. Alternatively the software and its associated data may be stored as one or more downloadable or remotely executable files that are accessible via a computer communications network such as the internet.

Hence, the processing of email text undertaken by the preferred embodiment advantageously identifies advertisements and quotations in addition to reply lines, signatures and text written by the author. This parsing may be performed with a comparatively high degree of accuracy. It is achieved with the use of a rich set of linguistic features, such as a database storing a plurality of named entities, common greetings and farewell phrases. The parsing also makes use of a comprehensive set of punctuation features. Additionally, the use of segmentation analysis provides further useful input to the parsing processing, for example to help avoid incorrectly categorizing half of a sentence as author composed text and the other half of a sentence as a reply line.

The preferred embodiment can advantageously function with input email text represented in a variety of formats. Advantageously, alternative preferred embodiments are configurable for use in parsing email text expressed in languages other than English. Provided the machine learning system is regularly re-trained on a contemporary set of training data, the preferred embodiment can effectively keep abreast of newly emergent email writing styles and expressions. This assists in maintaining a comparatively high degree of accuracy as the email writing genre evolves over time.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

1. A computer implemented method of parsing an email document so as to categorize text from the email document as author composed text or non-author composed text, said method including the steps of:
processing the text to determine the presence of signature text and categorizing any such signature text as non-author composed text;
processing the text to determine the presence of automatically appended advertisement text and categorizing any such automatically appended advertisement text as non-author composed text;
processing the text to determine the presence of quotation text and categorizing any such quotation text as non-author composed text;
processing the text to determine the presence of text contained in an embedded reply chain of email messages and categorizing any such text contained in an embedded reply chain of email messages as non-author composed text; and
categorizing at least some of the remaining text as author composed text.

2. A method according to claim 1 wherein at least one of the text processing steps includes a linguistic analysis of the words in the text.

3. A method according to claim 2 wherein said linguistic analysis includes identification of predefined words and phrases.

4. A method according to claim 3 wherein said words and phrases include any one or more of the following types:
peoples' names, locations, dates, times, organizations, currency, uniform resource locators (URL's), email addresses, addresses, organizational descriptors, phone numbers, typical greetings and/or typical farewells.

5. A method according to claim 4 further including a database of words and phrases of any one or more of the following types:
peoples' names, locations, dates, times, organizations, currency, uniform resource locators (URL's), email addresses, addresses, organizational descriptors, phone numbers, typical greetings and/or typical farewells.

6. A method according to claim 4 further including the step of anonymising information contained within the text of the email document.

7. A method according to claim 1 wherein at least one of the text processing steps includes an analysis of the punctuation used in the text.

8. A method according to claim 1 wherein at least one of the text processing steps includes an analysis of the paragraph segmentation used in the text.

9. A method according to claim 1 wherein at least one of the text processing steps includes an analysis of the sentence segmentation used in the text.

10. A method according to claim 1 wherein at least one of the text processing steps includes any one or more of:
a linguistic analysis of the words in the text,
an analysis of the punctuation used in the text;
an analysis of the paragraph segmentation used in the text; and/or
an analysis of the sentence segmentation used in the text,
and wherein the results of said analyses are represented by one or more data structures associated with segments of the text.

11. A method according to claim 10 wherein said segments of the text are lines of the text.

12. A method according to claim 10 wherein at least one of the text processing steps further includes utilizing a machine learning system that is responsive to said one or more data structures.

13. A method according to claim 12 wherein the data structures are feature vectors and the machine learning system utilizes any one or more of the following techniques:
Conditional Random Fields;
Support Vector Machines;
Naïve Bayes;
Decision Trees; and/or
Maximum Entropy.

14. A method according to claim 12 wherein the machine learning system has been trained with reference to a representative sample of email documents.

15. A method according to claim 14 wherein the representative sample of email documents includes a proportion of contemporary email documents.

16. A method according to claim 1 including a step of processing the text to determine the presence of header text and categorizing any such header text as non-author composed text.

17. A method according to claim 1 including a step of processing the email document to determine the presence of any attachments and stripping any such attachments from the email document prior to processing the text.

18. A method according to claim 1 including a step of processing the email document to determine the presence of any forwarded material and stripping any such forwarded material from the email document prior to processing the text.

19. A method according to claim 1 including a step of processing the email document to ascertain whether the email document is in a preferred format and, if the email document is not in the preferred format, converting at least some of the information within the email document to the preferred format.

20. The method according to claim 1 where the steps are implemented using a computer-readable medium containing computer executable code for instructing a computer.

21. The method according to claim 1 wherein the steps are contained in computer executable code in a selected one of the group consisting of a downloadable file, remotely executable file, and a combination of files containing computer executable code.

22. The method according to claim 1 where the steps are implemented by a computing apparatus having a central processing unit, associated memory and storage devices, and input and output devices.
